(19) United States
(12) Patent Application Publication
(10) Pub. No.: US 2008/0012488 A1
(43) Pub. Date: Jan. 17, 2008

(54) Light Bulb Containing an Illumination Body That Contains Carbide

(75) Inventors: Axel Bunk, Munchen (DE); Matthias Damm, Gaimersheim (DE); Georg Rosenbauer, Wassertrudingen (DE)

Correspondence Address: OSRAM SYLVANIA INC, 100 ENDICOTT STREET, DANVERS, MA, 01923, US

(73) Assignee: Patent-Treuhand-Gesellschaft Fur Elektrische Gluhlampen MBH, Munchen (DE)

(21) Appl. No.: 11/631,173

(22) PCT Filed: Jul. 6, 2005
(86) PCT No.: PCT/DE05/01198

§ 371 Date: Dec. 29, 2006

(30) Foreign Application Priority Data
Jul. 19, 2004 (DE) 102004034786.7

(51) Int. Cl. H01K 1/50

(52) U.S. Cl. 313/578

(57) ABSTRACT

The invention relates to a light bulb comprising an illumination body, which is inserted, together with a filler material, into a bulb in a vacuum-tight manner. The illumination body has a metal carbide, whose melting point lies above that of tungsten. The current supply is configured in two parts from a first section and a second section. The current supply is configured integrally with the illumination body from a single wire and is covered with a coating that reduces the susceptibility to breakage.

### TECHNICAL FIELD

The invention is based on an incandescent lamp having a carbide-containing luminous body in accordance with the precharacterizing clause of claim 1. The lamps in question here are in particular halogen incandescent lamps which have a luminous body consisting of TaC or whose luminous body contains TaC as a constituent part or coating.

### PRIOR ART

An incandescent lamp having a carbide-containing luminous body is known from many documents. Problems which have yet to be solved are the severely restricted life and the high susceptibility to breakage of the luminous body. One possibility mentioned in U.S. Pat. No. 1,854,970 for solving the problem associated with susceptibility to breakage consists in producing the luminous body from a metal core, for example tungsten, and a rhenium-containing layer applied thereto, a tantalum carbide coating then being applied.

Tantalum carbide has a melting point which is approximately 500 K higher than tungsten. The temperature of a luminous body consisting of tantalum carbide can therefore be set to be considerably higher than that of a luminous body consisting of tungsten. Owing to the higher temperature of the luminous body and the increased emission of the tantalum carbide in the visible spectral range, considerably higher luminous efficiencies can be realized with tantalum carbide lamps (=lamps with tantalum carbide as the luminous body) than with lamps having conventional incandescent bodies consisting of tungsten. Until now, it is predominantly the brittleness of the tantalum carbide and the rapid decarburization or decomposition of the luminous body at high temperatures which have stood in the way of marketing tantalum carbide lamps. In order to overcome the problem of the brittleness, patent literature has proposed, for example, the use of optimized carburization processes (DE 1.558.712, U.S. Pat. No. 3,650,850), the use of alloys of TaC with other carbides/materials (for example TaC+WC, TaC+HfC, etc., see U.S. Pat. No. 3,405,328, U.S. Pat. No. 4,032,809), and the use of support materials (U.S. Pat. No. 1,854,970).

In order to keep the complexity in terms of manufacturing as low as possible when constructing a TaC lamp, it is proposed to construct a TaC lamp having the same geometry as a conventional low-volt halogen lamp using quartz technology, see FIG. 3, for example.

FIG. 3 shows an incandescent lamp 1 having a pinch seal at one end and having a bulb 2 consisting of hard glass and a pinch seal 3, in which two foils 4 are embedded. In each case outer power supply lines 5 and inner power supply lines 6, which are connected in the interior of the bulb to an axial luminous body 7, end at the foil 4.

For this purpose, first filaments are manufactured from tantalum wire, and these filaments are used to construct rod-shaped lamps. Then, the luminous body consisting of tantalum wire in the rod-shaped lamp is carburized using a mixture of methane and hydrogen. As regards the basic properties for carburization, cf. for example, S. Okoli, R. Haubner, B. Lux, Surface and Coatings Technology 47 (1991), 585-599, and G. Hörz, Metall [Metal] 27, (1973), 680. In this context, two properties of the carburization reactions are relevant:

(1) During carburization, initially the brittle subcarbide Ta₂C is formed. Given a further supply of carbon, the TaC phase then forms.

(2) The carburization reaction takes place more rapidly the higher the temperature.

The simplest possibility for bringing the luminous body to the temperatures required for carburization consists in applying a suitable voltage to the luminous body. However, owing to thermal dissipation, a temperature drop occurs in the process from the ends of the luminous body towards the pinch seal. In any case sufficiently high temperatures can be set at the luminous body such that continuous carburization takes place. Directly above the pinch seal, the temperatures are so low (usually below 700° C.), however, that no carburization takes place at all. In this region, temperatures required for complete carburization can only be set with great difficulty. Located between the region directly at the pinch seal, in which a wire consisting of tantalum is still present, and the completely carburized luminous body there is a region in which the brittle subcarbide Ta₂C is present. When subjected to an impact, the luminous body preferably breaks precisely in this region. The object is now to protect or stabilize this region as much as possible such that the susceptibility to breakage in this region is reduced. This stabilization should at least make safe transport of the lamp to the customer possible.

One possibility consists in protecting the critical region in which the brittle subcarbide Ta₂C dominates by the use of a covering coil or sleeve, as is described in DE-Az 10 2004 014 211.4 (not yet published).

Alternatively, the luminous body consisting of tantalum can also be carburized before being inserted into the lamp. However, in this case handling of the filaments consisting of TaC is critical owing to the still considerable breakability of the TaC, with the result that this procedure is usually not an option.

### DESCRIPTION OF THE INVENTION

One object of the present invention is to provide an incandescent lamp having a carbide-containing luminous body, in particular with a halogen filling, in accordance with the precharacterizing clause of claim 1 which makes a long life possible and overcomes the problem of the breakability of the luminous body.

These objects are achieved by the characterizing features of claim 1. Particularly advantageous refinements can be gleaned from the dependent claims.

According to the invention, an integral luminous body is used for this purpose, in which the two power supply lines are a continuation of the wound luminous body. The luminous body and the power supply line are formed from a single wire. The power supply line is partially coated, it being expedient for there to be a certain distance between the coating and the luminous body. The distance is dependent on the temperature which is reached during operation at the point of the boundary between the coated and uncoated part of the power supply line.

In order to avoid or reduce the breakability of the luminous body in the region in which the brittle Ta₂C is present, two different embodiments of the coating are proposed.

The first preferred embodiment is based on the concept of, prior to carrying out the carburization of the TaC filament, protecting those points at which, owing to the lower temperatures occurring there, the carburization of the tantalum cannot be concluded and, accordingly, predominantly the brittle subcarbide Ta₂C is present, before carrying out the carburization by means of a coating. The coating is intended primarily to shield the tantalum in the corresponding regions from the carbon-containing atmosphere which is provided during carburization via the exhaust tube, such that no carburization takes place at these points. Only those regions of the luminous body (which originally consisted of tantalum) which are at very high temperatures above 2000° C., preferably above approximately 2300° C., are not provided with a protective layer and consequently are completely carburized to form TaC (the precise limit value depends on the respective boundary conditions), see FIG. 1 attached. The occurrence of the brittle subcarbide Ta₂C cannot be completely avoided owing to the longitudinal diffusion of carbon in the direction of the temperature gradient, but can be restricted to a relatively low range. Secondly, the coating can also be used for stabilizing the outgoing line if the narrow region of existence of the subcarbide is mechanically stabilized by a protective layer (avoidance of the formation of cracks occurring on the surface). The protective layer needs to at least withstand the carburization process in order to ensure safe transport of the lamps to the customer. Then, the protective layer, depending on the specific application, is not necessarily required any longer; (even partial) degradation of the protective layer by means of diffusion or chemical processes can then be accepted, under some circumstances. However, it is generally not desirable. The material of the protective layer should not melt or evaporate at temperatures at which the brittle subcarbide would occur without the protective layer, i.e. the melting point should be at least above approximately 2000° C., better even markedly higher. When protecting the transition region consisting of Ta₂C, in accordance with this basic principle it is essential that the coating is applied to the outgoing lines up to locations which are so close to the luminous body that the transition region between the uncoated and the coated locations on the outgoing line is already at such a high temperature that complete carburization of the tantalum to form tantalum carbide can take place at the region of the power supply line which directly follows on from the end of the coating. In general, the coating therefore needs to be so thin (at least in the regions close to the transition to the uncoated region) that no increased thermal dissipation is caused here by the coating. Typical layer thicknesses are from 1 to 50 μm. The respective value depends on the coating material used and the thickness of the wire to be coated. In “colder” regions close to the outgoing line, the coating may also be thicker in order, in addition to achieve mechanical stabilization here. The layer thickness can therefore follow a gradient, the layer thickness increasing continuously or suddenly in the direction of the pinch-seal edge.

In accordance with a second preferred embodiment, the outgoing lines are surrounded by a relatively thick layer of a material in order, firstly, to mechanically stabilize the outgoing lines and, secondly, to move the points with the brittle transition phase Ta₂C to locations which are so close to the luminous body that an increase in the impact strength occurs, when subjected to an impact, by “shortening of the lever arm”. Typical layer thicknesses are in the range of from 50 to 200 μm. In this case, the relatively thick protective coating takes on a similar function to that of the covering coil described in DE-Az 10 2004 014 211.4 (not yet published). In this case, in addition to the substances mentioned under basic principle 1, it is also possible to use, as the material for the protective coating, metals which form carbides with carbon, which are likewise brittle, but whose brittleness is not so pronounced as that of Ta₂C. Possible examples are the metals tungsten, molybdenum, hafnium, niobium or zirconium or carbides thereof. The use of the carbides of non-metals is also possible, such as, for example, boron carbide or silicon carbide.

For more stringent requirements, the use of a protective layer in accordance with the first embodiment is combined with the use of a covering coil as described in DE-Az 10 2004 014 211.4; this results in further advantages such as the increase in make-proofness. The coating prevents or delays the carburization at the outgoing lines; the covering coil ensures further stabilization. It is important that the coating is still extended beyond the end of the covering coil in the direction of the luminous body since such low temperatures often still occur at the end of the covering coil, at which temperatures the carburization cannot be concluded.

The invention described here relates in particular to lamps having a reduced bulb volume, the distance between the luminous body, in particular its luminous sections, from the inner wall of the bulb being at most 18 mm. In particular, the bulb diameter is at most 35 mm, in particular in the range of between 5 mm and 25 mm, preferably in the range of between 8 mm and 15 mm. Given a bulb with such small dimensions, in particular such a small diameter, the risk of deposition of solids on the bulb wall necessarily needs to be counteracted. Given such small bulb diameters, depending on the color temperature of the filament, blackening of the bulb can be markedly reduced or avoided by means of a two-cycle process, as is described in DE-Az 103 56 651.1 (as yet unpublished).

In one preferred embodiment, the power supply line is protected by it being covered at least partially with a coating.

The luminous body is in particular one which is arranged axially or transversely with respect to the axis in a bulb which is sealed, in particular pinch-sealed at one or two ends.

The luminous body is preferably a singly wound wire, whose ends, which are used as the power supply line, are not wound. Typical diameters of the wire for the luminous body are from 50 to 300 μm. The luminous body is typically formed from 5 to 20 turns. A preferred pitch factor for achieving stability of the luminous body which is as high as possible is 1.4 to 2.8.

Particularly preferably, the coating extends onto the region of the power supply line, which enters into the bulb material from the bulb interior. The bulb is normally closed off by one or two pinch seals. This region is referred to as a pinch-seal edge. In addition, the sensitivity to breakage precisely in the region of the pinch-seal edge is particularly high since a high bending moment occurs here.

Particularly preferably, the coating extends over at least 10%, preferably over at least 50% and particularly preferably over at least 80% of the length of the power supply line in the interior of the bulb. It is important for the coating in accordance with the first embodiment having a relatively thin layer that the coating is drawn up to points which are so close to the luminous body that the temperature at the unprotected points is already so high that complete carburization takes place here and the occurrence of the brittle subcarbide Ta₂C is avoided. A coating in accordance with the second embodiment acts as a support; it should be drawn up as far as possible at the outgoing line in order to achieve stabilization which is as great as possible.

This aspect has particular significance owing to the fact that the concept of the axial luminous body is in principle well suited for applying an efficiency-increasing covering to the bulb. A so-called infrared coating (IRC), as is described, for example, in U.S. Pat. No. 5,548,182, is known. Correspondingly, the bulb can also be adapted specially for this, for example be provided with an elliptical or cylindrical shape, as is known per se.

One particular advantage consists in the use of halogen fillings, since, given suitable dimensions, not only a cycle process for the material of the luminous body but also for the material of the coating can be set in motion. One example is an Re—Br cycle process using Re as the coating material and Br as the active halogen. Such fillings are known per se. In particular, the filling here is a filling for a two-cycle process, as is described in DE-A 103 56 651.1 (as yet unpublished).

Furthermore, the design according to the invention is considerably simpler than previous designs since, in particular for LV applications up to a maximum of 80 V, no quartz bar is required and since it is usually possible to dispense with a covering coil, and since, in addition, no problematic contact-making operations are required between an already fully carburized luminous body consisting of TaC and the power supply lines (welding or clamping and/or crimping). When handling an already fully carburized luminous body consisting of TaC, damage often occurs at the ends of the luminous body owing to the brittleness of the material.

The material of the luminous body is preferably TaC. However, carbides of Hf, Nb or Zr are also suitable. In addition, alloys of various carbides, for example of TaC and of HfC, are suitable.

The present invention is particularly suitable for low-volt lamps having a voltage of at most 50 V, since the luminous bodies required for this purpose can be designed to be relatively solid and, for this purpose, the wires preferably have a diameter of between 50 μm and 300 μm, in particular at most 150 μm for general lighting purposes with a maximum power of 100 W. Thick wires up to 300 μm are used in particular in the case of photooptical applications up to a power of 1000 W. Particularly preferably, the invention is used for lamps having a pinch seal at one end, since in this case the luminous body can be kept relatively short, which likewise reduces the susceptibility to breakage. However, the use for lamps having a pinch seal at two ends and system voltage lamps is likewise conceivable.

### BRIEF DESCRIPTION OF THE DRAWINGS

The invention will be explained in more detail below with reference to a plurality of exemplary embodiments. In the drawings:

FIG. 1 shows an incandescent lamp having a carbide luminous body in accordance with a first exemplary embodiment;

FIG. 2 shows an incandescent lamp having a carbide luminous body in accordance with a second exemplary embodiment; and

FIG. 3 shows an incandescent lamp having a carbide luminous body in accordance with the prior art.

### PREFERRED EMBODIMENT OF THE INVENTION

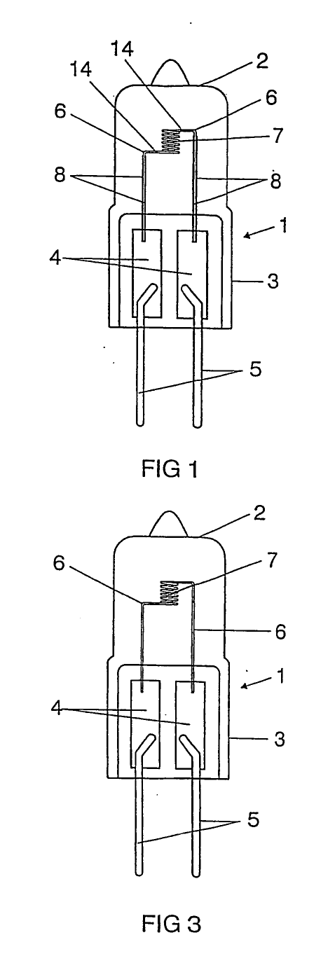

FIG. 1 shows an incandescent lamp 1 having a pinch seal at one end and having a bulb consisting of quartz glass 2, a pinch seal 3, and inner power supply lines 6, which connect foils 4 in the pinch seal 3 to a luminous body 7. The luminous body is a singly wound, axially arranged wire consisting of TaC, whose unwound ends 14 extend further transversely with respect to the lamp axis. The outer feed lines 5 are attached on the outside to the foils 4. The inner diameter of the bulb is 5 mm. The filament ends 14 are then bent back parallel to the lamp axis and form the inner power supply lines 6 there as an integral extension. The power supply lines 6 are provided with a coating 8 at least over that part of their total length which does not get hotter than 2000° C. during operation. This coating consists of a material as illustrated below.

### Exemplary Embodiments for the First Embodiment

For example, the metals rhenium (melting point: 3453 K), ruthenium (melting point: 2583 K), osmium (melting point: 3318 K), and iridium (melting point: 2683 K) do not form any carbides or only form carbides to a low extent. Carbon is only soluble in them to a relatively low extent. They are largely impermeable to carbon, cf., for example, as regards the use of rhenium in the luminous body, the patent specification U.S. Pat. No. 1,854,970. One possibility therefore consists in surrounding those regions of the luminous body (which initially consists of tantalum) that are only heated to temperatures below approximately 2500 K with a protective layer consisting of these metals. Since, at high temperatures, tantalum and the material of the mentioned metals diffuse with one another, the thickness of the protective layer needs to be great enough to withstand at least the carburization process. Layer thicknesses are typically between 1 μm and 50 μm, depending on the nature of the carburization process. The application of the metals can take place, for example, by electrolysis, CVD deposition or sputtering processes.

Alternatively, the material of the protective layer may also consist of high-melting compounds, which should not react either with the tantalum of the outgoing lines of the luminous body or with the carbon-containing atmosphere of the lamp and should not diffuse into the tantalum.

For example, HfB₂, ZrB₂, NbB₂ and TiB₂ are stable at least up to 2800 K to a reaction with carbon-containing compounds from the gas phase to form carbides. Furthermore, the compounds HfB₂, ZrB₂ and NbB₂ are stable to a reaction with tantalum over the entire temperature range relevant here, but TiB₂ reacts with tantalum to form TaB₂ (the resultant titanium in any case has a melting point which is too low). Thus, for example, HfB₂, ZrB₂ and NbB₂ are possible materials for the required protective layers, since they do not react either with the substrate consisting of tantalum or with the carbon-containing atmosphere of the lamp. In this case, relatively small layer thicknesses can be used which are preferably in the range of between 0.5 μm and 5 μm. The use of tantalum boride (possibly to be achieved by boriding of the surface) may also be expedient in individual cases since the tantalum boride does not react with the carbon in the gas phase and the boron first needs to diffuse into the interior of the wire, as a result of which further diffusion of the carbon is delayed for a sufficiently long period of time.

The nitrides HfN, ZrN, NbN, TiN, VN and TaN are stable to a reaction with carbon (originating from the methane) to form carbides only up to temperatures around approximately 1000 K or below. In particular, ZrN does not react with the carbon in the lamp atmosphere up to relatively high temperatures (approximately 1500 K), and HfN (resistant up to 1100 K) is also relatively stable. ZrN and HfN do not react with tantalum to form TaN in the temperature range in question, i.e. zirconium nitride and hafnium nitride are more stable than tantalum nitride. On the other hand, NbN and VN can react with the tantalum to form TaN; TiN decomposes at temperatures which are too low of around 2000 K. The two materials HfN and ZrN are therefore necessarily suitable as the material for protective coverings. A specific reaction time is required for the reaction of HfN and ZrN at high temperatures above approximately 1500 K to form the respective carbides, which specific reaction time, depending on the procedure during carburization and the thickness of the applied layers, may be sufficient for protecting the region of the tantalum wire lying therebeneath from carburization. In a similar manner, coating of the tantalum wire in the region in question with TaN may also in individual cases be sufficient for slowing down carburization of the region in question such that, in practice, it is insignificant during carburization of the luminous body.

One further possibility consists in the use of systems of two layer materials. For example, the tantalum wire may first be coated with ZrN or HfN, both of which do not react with tantalum in the range of temperatures in question. The first layer applied to the tantalum can then still be coated with, for example, rhenium, osmium etc., which do not react either with the ZrN or HfN or with the carbon from the lamp atmosphere. In this manner, the respectively less desirable properties of the individual layer systems (namely the diffusion of the metals rhenium, osmium etc. into the tantalum and the reaction of zirconium nitride and hafnium nitride to form the respective carbides) can be circumvented. Such systems are stable over relatively long periods of time.

Furthermore, the region in question of the tantalum wire can be coated with boron nitride. The decomposition of the boron nitride with subsequent reaction of the tantalum to form tantalum (di)boride or else the less stable tantalum nitride usually progresses so slowly that the carburization of the tantalum is delayed for a sufficiently long period of time. Similarly, boron carbide can be used, in the case of whose decomposition the more stable tantalum (di)boride is preferably produced, and not the tantalum carbide. The carburization is delayed by the time required for the decomposition of the boron carbide, the reaction with the tantalum and the diffusion of the boron atoms into the interior of the tantalum.

A particular case of above-described examples is the passivation of the outgoing lines (which consist of tantalum prior to carburization) by means of boriding or nitriding, as a result of which, in the subsequent carburization process, the carburization is delayed or suppressed for a sufficiently long period of time in the critical temperature range. In these cases, no protective layer is applied to the outgoing lines, but the surface is “passivated” by chemical reaction of the tantalum with boron or nitrogen or the speed of the carburization is reduced sufficiently.

### Exemplary Embodiments for the Second Embodiment

The outgoing lines of the luminous body are in this case coated with a layer, whose thickness is preferably in the range of between one tenth and half the diameter of the tantalum wire to be coated. Suitable coating materials are, in addition to the metals mentioned in the description of basic principle 1, also tungsten, molybdenum, hafnium, zirconium or other carbide-forming materials. In the simplest case, the protective layer consists of tantalum, or, from the beginning, tantalum wires having a larger diameter than in the region of the luminous body are used in the region of the outgoing lines.

The described procedures can also be transferred to lamps having carbides of other metals than that of the luminous body, such as hafnium carbide or zirconium carbide or niobium carbide.

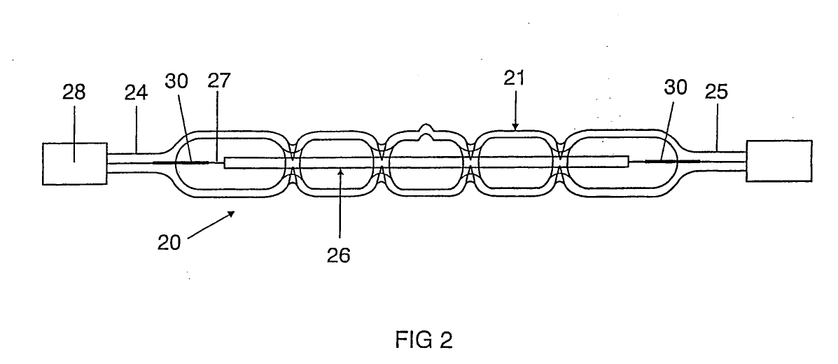

FIG. 2 shows an incandescent lamp 20 having a pinch seal at two ends, also known as a double-ended lamp, having a bulb consisting of quartz glass 21, two pinch seals 24 and 25, feed lines 27, which are connected to a luminous body 26. The inner diameter of the bulb is 15 mm. The luminous body 26 is wound singly and consists of TaC. The power supply lines 27 are partially sheathed by a coating 30 consisting of hafnium boride and end in base parts 28, as is known per se, which rest on the pinch seal 24, 25.

In addition, the coating or part of the coating, which part does not include the peak temperature achieved at the coating, can also be surrounded by a casing consisting of filament wire or a fixed sleeve, for example consisting of molybdenum, as is described, in principle, in DE-Az 10 2004 014 211.4 (as yet unpublished).

In general, the lamp preferably uses a luminous body consisting of tantalum carbide, which preferably comprises a singly wound wire.

The bulb is manufactured from quartz or hard glass with a bulb diameter of between 5 mm and 35 mm, preferably between 8 mm and 15 mm.

The filling is primarily inert gas, in particular noble gas such as Ar, Kr or Xe, possibly with the admixture of low quantities (up to 15 mol %) of nitrogen. Added to this are a hydrocarbon, hydrogen and a halogen additive.

Zirconium carbide, hafnium carbide or an alloy of various carbides is also suitable as the luminous body material, which is preferably a wound wire, as described, for example in U.S. Pat. No. 3,405,328.

One alternative is a luminous body which comprises a support material such as, for example, a rhenium wire as the core or else a carbon fiber, this core being coated with tantalum carbide or another metal carbide, see in this regard the application DE-Az 103 56 651.1 (as yet unpublished).

One further possibility consists in first depositing carbon on the luminous body consisting of TaC, for example by means of heating the TaC luminous body in an atmosphere with a high CH₄ concentration. Tantalum carbide is then deposited on this carbon layer. For example, in a CVD process, tantalum can be deposited which is then carburized either by the surrounding carbon and/or from the outside by being heated in an atmosphere containing, for example, CH₄. This has the advantage over the coating of, for example, carbon fibers that the TaC luminous body (based on tantalum) can be produced more easily in any desired shapes.

As elemental rules for the filling, a carbon content of from 0.1 to 5 mol %, in particular up to 2 mol %, applies. The hydrogen content is at least the carbon content, preferably two to eight times the carbon content. The halogen content is at most half, in particular one fifth up to one twentieth, in particular one tenth, of the carbon content. Preferably, the halogen content should correspond at most to the hydrogen content, preferably at most to half the hydrogen content. A guideline for the halogen content is from 500 to 5000 ppm. All of these figures relate to a coldfilling pressure of 1 bar. Given changes in the pressure, the individual concentration figures should be recalculated such that the absolute amounts of substance are maintained; for example halve all concentration figures in ppm given twice the pressure.

Specific experiments are presented for a 24 V/100 W lamp. The color temperature is 3800 K. It uses a TaC wire (obtained from carburized tantalum) with a diameter of 125 μm. It is wound singly and displays a markedly improved breakage response in comparison with lamps having uncoated outgoing lines. The breakage tests were carried out with an impact pendulum.

On the other hand, an otherwise identical lamp, which, however, uses the conventional rigid electrode holders consisting of molybdenum or tungsten, is considerably more susceptible to breakage since, when solid Mo holders are used, the points of the luminous body which are close to the connection point between the Mo electrode and the filament (which initially consists of tantalum) are at such a low temperature that the carburization cannot be concluded, i.e. the brittle subcarbide dominates there. In this case, the power supply lines fixed to the Mo or W holder and leading to the luminous body are therefore covered by a layer which suppresses the carburization of the luminous body in the manner described above, with the result that no subcarbide can be produced at this point, see FIG. 4. Only in the transition region between the coated and the uncoated part does subcarbide occur to a limited extent. However, the overall design is therefore very complex.

In addition, the electrodes, i.e. solid power supply lines usually consisting of molybdenum or tungsten, slowly absorb carbon from the gas phase during lamp operation and therefore act as “getters” for carbon, at least in the hotter regions close to the point at which the luminous body is fixed. As a result, the cycle process in the lamp is disrupted; it is no longer possible for carbon to be passed back to the luminous body. In order to avoid this or at least to delay the carbon absorption, it is recommended in most cases when using this design to protect the electrode, at least in the region of higher temperatures thereof, with a layer suppressing carburization. For example, the electrodes can be coated with a layer consisting of the abovementioned metals rhenium, osmium, ruthenium or iridium. Alternatives are the coatings of the electrodes with, for example, hafnium boride, zirconium boride and niobium boride. Since, for example, molybdenum boride is more stable than molybdenum carbide, the electrodes can be passivated from the outside by means of boriding. A further possibility consists in coating the Mo or W electrodes with nitrides such as hafnium nitride, zirconium nitride, niobium nitride; although these compounds are converted slowly into carbides during carburization or during lamp operation, the time required for this is sufficiently long given a sufficiently thick layer thickness. It is also possible for the solid power supply lines to be formed completely from one of the mentioned metals.

Luminous bodies provided with a coating are suitable for transport of the lamp under conventional conditions. In other designs, the luminous body is so sensitive to breakage that special measures would need to be taken for the transport of the lamp.

Buckling of the luminous body is reduced the shorter the outgoing filaments are selected to be. The cause of the buckling is the increase in volume during carburization. This increase is noticeable in particular from an increase in the length. It has been shown that the disruptive buckling does not lead to canting within the turns of the luminous body, but the luminous body cants as a whole to the side from the axial position. Avoidance of buckling is an imperative prerequisite for using interference filters on the bulb as an IRC coating, as is known per se, see EP 765 528.

The outer diameter when additionally using a sleeve corresponds at most to twice the diameter of the wire of the luminous body. The thinner the sleeve, the lower its weight is.

In this sense, it goes without saying that the covering is applied directly to the power supply line such that it bears as tightly as possible. The provision of a gap and the additional introduction of material by means of a supporting aid which is also inserted into the covering in the form of an additional wire, as in U.S. Pat. No. 3,355,619, is not expressly ruled out, however. On the one hand, this additional wire can act as an additional supporting aid. On the other hand, additives or the complete filling gas additive for the filling gas cycle process can be introduced in solid form into the lamp at the outgoing filaments, for example coated carbon fibers or plastic fibers of halogenated hydrocarbon compounds.

There is a very specific filling consisting of the following components for a lamp having a diameter of the bulb of 10 mm and a luminous body consisting of TaC: 1 bar (coldfilling pressure) Kr+1% C₂H₄+1% H₂+0.05% CH₂Br₂. The concentration figures are in mol %.

Even if the power supply lines and the luminous body are manufactured integrally from one part, this does not exclude the possibility of the material of the power supply lines having contents of the metal or of the metal carbide in the luminous body with another stoichiometry. This is the case in particular when a coating material such as rhenium diffuses into a wire consisting of another metal, such as tantalum.

1. An incandescent lamp having a carbide-containing luminous body and having power supply lines, which hold the luminous body, a luminous body being introduced in a vacuum-tight manner together with a filling in a bulb, the luminous body having a metal carbide whose melting point is above that of tungsten, characterized in that the power supply lines are manufactured integrally with the luminous body from a wire, and in that at least part of the power supply line is surrounded by a coating.

2. The incandescent lamp as claimed in claim 1, characterized in that the luminous body consists of tantalum carbide at least at its surface, and in particular is a singly wound wire.

3. The incandescent lamp as claimed in claim 1, characterized in that the bulb consists of quartz glass or hard glass having a bulb diameter of between 5 mm and 35 mm, preferably between 8 mm and 15 mm.

4. The incandescent lamp as claimed in claim 1, characterized in that the filling contains inert gas, in particular noble gas, possibly with an admixture of low quantities of nitrogen, and at least one hydrocarbon, hydrogen and at least one halogen additive.

5. The incandescent lamp as claimed in claim 1, characterized in that the luminous body is a singly wound wire, preferably having a diameter of from 50 to 300 μm, in particular up to 150 μm.

6. The incandescent lamp as claimed in claim 1, characterized in that the coating on the power supply line extends up to a point which is so close to the luminous body that the temperature of the uncoated part of the power supply line is at least 2000° C. or above.

7. The incandescent lamp as claimed in claim 1, characterized in that the thickness of the coating is a maximum of ¼ of the diameter of the wire.

8. The incandescent lamp as claimed in claim 6, characterized in that the coating consists of rhenium or osmium or iridium or ruthenium or mixtures thereof.

9. The incandescent lamp as claimed in claim 7, characterized in that the coating consists of a boride of hafnium or of zirconium or of niobium or of tantalum or a mixture thereof.

10. The incandescent lamp as claimed in claim 1, characterized in that the coating consists of a metal nitride, in particular hafnium nitride or zirconium nitride or tantalum nitride, or of a nonmetallic compound, in particular of boronitride or of borocarbide or of silicon carbide or a mixture thereof.

11. The incandescent lamp as claimed in claim 1, characterized in that the power supply lines are sealed off in one or two sealing parts of the bulb, the coating extending at least up to the boundary face of the sealing part.

12. The incandescent lamp as claimed in claim 1, characterized in that the power supply lines consist of metal, in particular tantalum, and the luminous body consists of metal carbide, in particular tantalum carbide, the power supply lines being provided with a coating which has been achieved by the power supply lines being passivated by a previously conducted chemical reaction of the metal up to a point which is so close to the luminous body that the temperature of the non-passivated part is at least 2000° C. or above.

13. The incandescent lamp as claimed in claim 12, characterized in that the coating consists of tantalum boride or tantalum nitride or a mixture thereof.

14. The incandescent lamp as claimed in claim 1, characterized in that the thickness of the coating is at least 1/15 of the diameter of the wire of the power supply line.

15. The incandescent lamp as claimed in claim 1, characterized in that the luminous body consists of tantalum carbide, the coating consisting of the materials tungsten or molybdenum or hafnium or zirconium or tantalum or niobium or possibly carbides thereof.

16. The incandescent lamp as claimed in claim 1, characterized in that the layer comprises a first coating, a second coating or casing being applied to the first coating which partially or completely covers the first coating.

17. The incandescent lamp as claimed in claim 16, characterized in that the first layer applied to the power supply line does not react with the material of the power supply line, and the second layer, which is in contact with the filling, does not react with the filling, and the materials of the two layers do not react with one another and do not diffuse into one another, at least during the carburization period.

18. The incandescent lamp as claimed in claim 16, characterized in that the first layer, which is applied directly to the power supply line, consists of zirconium nitride or hafnium nitride, and the second layer, which is in contact with the filling, consists of rhenium or osmium.

19. The incandescent lamp as claimed in claim 1, characterized in that the power supply line to the luminous body is fixed to a further power supply line, which consists, for example, of W or Mo and has a considerably larger diameter, the so-called electrode, the power supply lines to the luminous body being coated over their entire length or only partially in the hotter regions close to the point at which the luminous body is fixed in a manner described in the preceding claims.

20. The incandescent lamp as claimed in claim 19, characterized in that the electrode is coated on the surface with rhenium or osmium or ruthenium or iridium.

21. The incandescent lamp as claimed in claim 19, characterized in that the electrode is coated on the surface with borides, such as, for example, hafnium boride or niobium boride or zirconium boride or nitrides, such as hafnium nitride, niobium nitride or zirconium nitride.

22. The incandescent lamp as claimed in claim 19, characterized in that the electrode is passivated on the surface, in particular by means of boriding.
